(19) United States
(12) Patent Application Publication
(10) Pub. No.: US 2008/0080513 A1
(43) Pub. Date: Apr. 3, 2008

(54) ANYCAST ROUTING METHOD AND APPARATUS FOR SUPPORTING SERVICE FLOW IN INTERNET SYSTEM

(76) Inventors: Yoo Hwa KANG, Daejeon (KR); Tae Il KIM, Daejeon (KR); Hae Won JUNG, Daejeon (KR)

Correspondence Address: LADAS & PARRY LLP, 224 SOUTH MICHIGAN AVENUE, SUITE 1600, CHICAGO, IL, 60604, US

(21) Appl. No.: 11/861,454

(22) Filed: Sep. 26, 2007

(30) Foreign Application Priority Data
Sep. 29, 2006 (KR) 10-2006-0096576

(51) Int. Cl. H04L 12/50

(52) U.S. Cl. 370/392

(57) ABSTRACT

An anycast routing method and apparatus for supporting a consecutive service flow are provided. In the any cast routing method, an anycast service is requested to at least one of the servers, and a packet including a destination option header with an anycast address is received as a response for the anycast service request from at least one of the servers. Then, the anycast address is stored in an anycast cache. The packet is transmitted through an anycast routing operation using the anycast address stored in the anycast cache if data to transmit to the service flow of at least one of the servers is received from an application.

### CLAIM OF PRIORITY

This application claims the benefit of Korean Patent Application No. 10-2006-96576 filed on Sep. 29, 2006 in the Korean Intellectual Property Office, the disclosure of which is incorporated herein by reference.

### BACKGROUND OF THE INVENTION

1. Field of the Invention

The present invention relates to an anycast routing apparatus and method and, more particularly, to an anycast routing apparatus and method for guaranteeing a continuous service flow in an Internet protocol version 6 (IPv6) based Internet system.

This work was supported by the IT R&D program of MIC/IITA [2006-S-061-01, R&D on Router Technology for IPv6 based QoS Services and Host Mobility]

2. Description of the Related Art

In general, anycast is routing scheme to establish communication among a single transmitter and nearest receivers within a predetermined group. An anycast address designates a set of interfaces belonging to various nodes, and a packet assigned with the anycast address is delivered to a single interface recognized as the nearest interface based on the anycast address. Herein, the nearest interface means the shortest routing distance. The anycast address is used to one-to-one communication that delivers a packet to the single interface. For example, a DNS server or a ‘6 to 5 relay’ router is one of the representative anycast addresses.

Hereinafter, a conventional anycast routing method using an anycast address will be described with reference to FIG. 1. Referring to FIG. 1, a terminal transmits a packet having an anycast address as a destination address to a first router, a default router. Then, the first router performs the anycast routing operation with reference to a routing table to transmit the packet from the first router to the destination address. As shown in FIG. 1, the routing table of the first router includes the routing entries of anycast servers A, B, and C, and the first router selects the server A and the server C, which have smaller distance values. Therefore, the first router transfers the anycast packets by distributing the packets through the server A and the server C based on a load balancing scheme.

As shown, the conventional anycast routing method cannot guarantee consecutive packets of a service flow to continuously transmit to one fixed anycast server. In case of providing a service through transmitting and receiving consecutive packets between a terminal and servers, a related service may be interrupted because the conventional anycast routing operation transfers packets to one of the servers in a server group unlike a DNS service that provides a service through transmitting and receiving only one packet between a terminal and a server.

That is, the conventional anycast routing method is disadvantageously limited to provide a single request/response UDP protocol service. In order to support most of services that exchanging consecutive packets between a terminal and a server, a new routing method is required to transfer a corresponding service flow to one fixed anycast server.

An application generally sustains a connection state using UDP/TCP, and anycast packets cannot be guaranteed to transfer to the same server. Also, the conventional anycast routing method cannot sustain the connection state in RFC 1546. In consideration of these factors, another conventional anycast routing method was introduced in order to sustain the connection state. In another conventional anycast routing method, an application obtains the unicast address of an anycast server when the application firstly transmits UDP data or when the application firstly establishes TCP connection. Then, the application uses the obtained unicast address to sustain the connection state.

In order to obtain the unicast address of the opponent at the application, the application, however, needs a supplementary method for obtaining the unicast address and to manage the unicast address as well as the anycast address. Also, the application is required to re-establish the connection using the obtained unicast address. In this case, a function for restricting a service to use the anycast address cannot be used.

Therefore, the application must guarantee the transparency to use an anycast address for the continuous service flow and needs a method for sustaining the connection state using minimum additional functions while supporting the conventional anycast routing method.

Unlike the Internet protocol version 4 (IPv4) that does not support anycast address, the Internet protocol version 6 (IPv6) provides unicast, multicast, and anycast address, and also supports anycast that is a routing scheme to establish communication among a single transmitter and nearest receivers within a predetermined group. The IPv6 can determine which one of anycast servers is closet and can transmit packets to a corresponding server like as the unicast routing communication.

The IPv6 also supports to transmit packets to the nearest anycast server within a group. However, the IPv6 cannot support to transmit consecutive packets of a continuous service flow to the same anycast server, where the continuous service flow exchange at least one of packets between a terminal and a server. Therefore, the IPv6 based anycast routing method cannot guarantee a service to be continuously provided.

### SUMMARY OF THE INVENTION

The present invention has been made to solve the foregoing problems of the prior art and therefore an aspect of the present invention is to provide an anycast routing method and apparatus for transmitting at least one of packets to the same anycast server in order to guarantee the continuity of a service flow in an IPv6 based Internet system.

According to an aspect of the invention, the invention provides an anycast routing method for guaranteeing a service flow transmitting to at least one of servers in a group in a terminal of an IPv6 (Internet protocol version 6) Internet system, including: requesting an unicast service to at least one of the servers; receiving a packet including a destination option header with an anycast address as a response for the anycast service request from at least one of the servers; storing the unicast address in an anycast cache; and transmitting a packet through an unicast routing operation using the unicast address stored in the anycast cache if data to transmit to the service flow is received from an application.

According to another aspect of the invention, there is provided an anycast routing method for guaranteeing a service flow receiving from a terminal in at least one of servers in a group of an IPv6 (Internet protocol version 6) Internet system, including: transmitting a packet having a destination option header setup with a unicast address according to an anycast service request from the terminal; receiving a packet having a routing header setup with an anycast address from the terminal through a unicast routing operation; and processing the received packet.

According to still another aspect of the invention, there is provided an anycast routing apparatus for guaranteeing a service flow transmitting to at least one of servers in a group in a terminal of an IPv6 (Internet protocol version 6) based Internet system, including: an anycast cache manager for receiving a packet having a destination option header setup with a unicast address as a response for an anycast service request from at least one of the servers, storing the unicast address in an anycast cache, and removing the unicast address from the anycast cache; and a routing header generator for looking up the anycast cache to find a corresponding unicast address when receiving data of a service flow to transmit to at least one of the servers and transmitting a packet having a routing header using the corresponding unicast address through a unicast routing operation.

According to yet another aspect of the invention, there is provided an anycast routing apparatus for guaranteeing a service flow receiving from a terminal in at least one of servers in a group of an IPv6 (Internet protocol version 6) Internet system, including: a unicast address transmitter for transmitting a packet having a destination option header setup with a unicast address according to an anycast service request from the terminal; and a routing header processor for receiving and processing a packet having a routing header setup with an anycast address through a unicast routing operation from the terminal.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a diagram for describing a conventional anycast routing method;

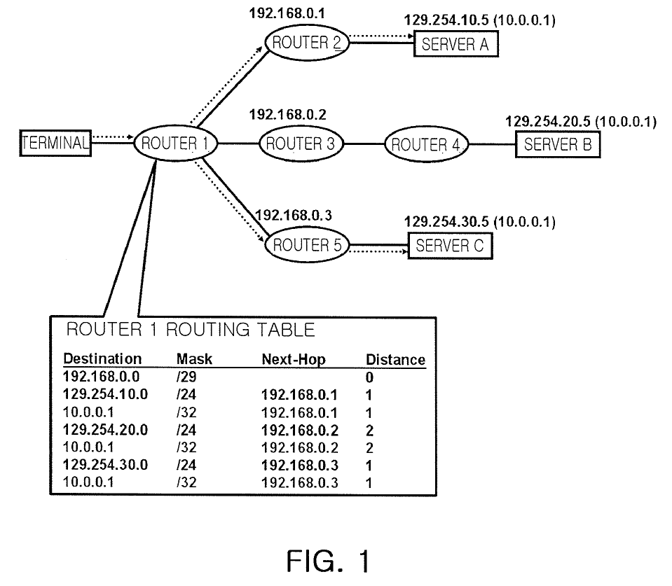

FIG. 2 is a block diagram illustrating an anycast routing apparatus for guaranteeing a continuous service flow in an Internet system (IPv6) according to an embodiment of the present invention;

FIG. 3 is a diagram for describing an anycast routing method for guaranteeing a continuous service flow according to an embodiment of the present invention;

FIG. 4 is a diagram for describing an anycast routing method for guaranteeing a continuous service flow between a terminal and a server according to an embodiment of the present invention;

FIG. 5 is a diagram illustrating a procedure of processing an anycast packet between a terminal and a server for guaranteeing a continuous service flow according to an embodiment of the present invention;

FIG. 6 is a flowchart illustrating an anycast routing method for guaranteeing a continuous service flow at a terminal according to an embodiment of the present invention; and

FIG. 7 is a flowchart illustrating an anycast routing method for guaranteeing a service flow at a server according to an embodiment of the present invention.

### DETAILED DESCRIPTION OF THE PREFERRED EMBODIMENT

Certain embodiments of the present invention will now be described in detail with reference to the accompanying drawings. Like numeral references denote like elements throughout the accompanying drawings. In order to clearly describe the present invention, the descriptions of well-known elements and functions are omitted.

In the certain embodiments of the present invention, an Internet system employs an Internet protocol version 6 (IPv6) Since the IPv6 supports various types of expanded headers, an IP layer can be used without defining additional protocols. Hereinafter, an anycast routing method and apparatus for guaranteeing the continuity of a service flow in the IPv6 based Internet system will be described.

Anycast is routing scheme to transmit packets from a single transmitter and nearest receivers within a predetermined group, and Unicast denotes routing scheme to transmit packets from a single transmitter to a single receiver. In general, most of Internet application programs use the unicast routing scheme.

And, consecutive packets can be transmitted to other anycast servers. In order to provide the continuity of a service, the terminal must transmit the consecutive packets of the continuous server flow to the same anycast server.

Hereinafter, an anycast routing apparatus in an Internet system according to an embodiment of the present invention will be described with reference accompanying drawings.

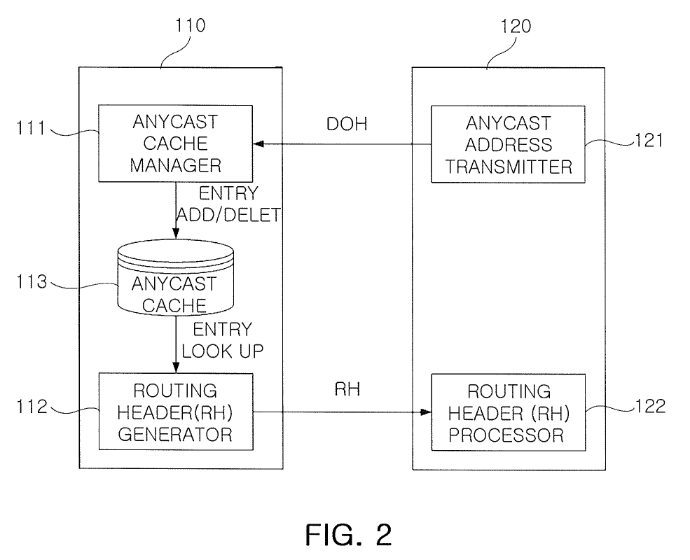

FIG. 2 is a block diagram illustrating an anycast routing apparatus for guaranteeing a continuous service flow in an Internet system (IPv6) according to an embodiment of the present invention.

The Internet system includes a terminal for transmitting an anycast packet, at least one of servers for transmitting a packet including an unicast address to the terminal as a response for the anycast packet, a plurality of routers disposed between the terminal and the servers, and a service storing unit.

The anycast routing apparatus for guaranteeing the continuity of a service flow in an Internet system according to the present embodiment will be described based on the terminal 110 and the server 120 with reference to FIG. 2.

The terminal 110 includes an anycast cache manager 111, a routing header generator 112, and an anycast cache 113. The terminal 110 inserts an anycast address into data transferred from the application using an IPv6 expanded header and transmits the data to the server 120 through the unicast address received from the server 120.

The server 120 includes a unicast address transmitter 121 and a routing header processor 122. The server 120 inserts a unicast address into the IPv6 expanded header and transmits the unicast address to the terminal 110 as a response for the anycast packet received from the terminal 110.

The anycast cache manager 111 stores the mapping relation {anycast address, unicast address} of the unicast address transferred from the server 120 into the anycast cache 113. Herein, the unicast address is stored in the destination option header (DOH) and transmitted to the terminal 110, where the destination option header (DOH) is an IPv6 expanded header. The anycast cache manager 111 also stores the protocol port number of a packet into the anycast cache 113. The terminal 110 uses the stored protocol port number to identify each service flow to transmit packets to a corresponding server 120 when a plurality of service flows from the terminal 110 to the servers 120 are present. The anycast cache manager 111 removes corresponding entries when an entry timer (not shown) expires.

When the destination address of a packet to transmit from an application is an anycast address, the routing header generator 112 finds a corresponding unicast address from the anycast cache and adds an IPv6 routing header and stores the unicast address. The routing header generator 112 exchanges the anycast address that is the destination address of the packet with the unicast address of the IPv6 routing header, and transmits the packet to the server 120.

The unicast address transmitter 121 of the server 120 transmits the unicast address to the anycast cache manager 111 of the terminal 110 when the server 110 transmits a response for the first packet having the anycast address as a destination. Herein, since the unicast address is additionally included into a destination option header (DOH) that is an IPv6 expanded header, and since the terminal 110 stores the unicast address in the anycast cache 113, the unicast address is not required to be inserted into packets transmitted after transmitting the first packet.

When the packet transmitted from the terminal 110 includes the IPv6 routing header (RH), the routing header processor 122 exchanges the unicast address of the destination address and the anycast address stored in the routing header, removes the routing header, and transmits data to the application. When the routing header processor 122 processes the IPv6 routing header, the routing header processor 122 processes the routing header similar to that in a mobile node (MN) when an address stored in an added routing type Π header is a home address (HA) used as a mobile node Identification. Therefore, the application can effectively use an anycast address regardless of performing actual unicast routing.

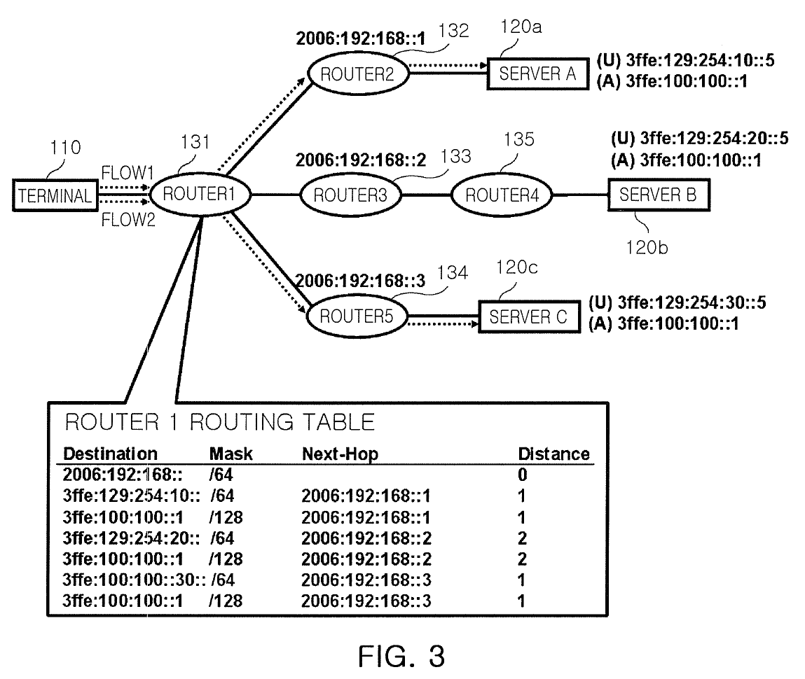

With reference to FIG. 3, an anycast routing method for the shown anycast routing apparatus will be descried based on the addresses of packets of a service flow transferred from the anycast routing apparatus, hereinafter. In FIG. 3, a dotted line denotes a packet path.

Referring to FIG. 3, the terminal 110, for example, transfers packets corresponding to two service flows 1 and 2 to the server A 120a and the server C 120c. The addresses of routers 132, 133, and 134 are setup as 266:192:168::1, 266:192:168::2, and 266:192:168::3. The anycast address is setup as (A)3ffe:100:100::1. The unicast addresses of the servers 120a to 120c are setup as (U)3ffe:129:254:10::5, (U)3ffe:129:254:20::5, and (U)3ffe:129:254:30::5. Accordingly, the terminal 110 transmits the first packet of a service flow to the anycast address server ((A)3ffe:100:100::1), and the first router 131 transmits packets of the flows 1 and 2 to the server A 120a and C 120c for load balancing. After receiving the packets, the servers 120a or 120c transfer a packet having own unicast address ((U)3ffe:129:254:10::5 or (U)3ffe:129:254:30::5) using the IPv6 expanded header to the terminal 110 as response. Then, the terminal 110 maps the unicast address (U) to the anycast address (A) for each flow. Such mapping relation is shown in the routing table of the first router 131. As shown, the mapped unicast address (U) and anycast address (A) are identified by MASK (/64, /128). The routing table includes the address of a next hop (router) and a distance thereof. For example, a packet to transfer to the server B 120b is transferred from the first router through the third and fourth routers. Therefore, the distance thereof is 2.

Hereinafter, an anycast routing method for guaranteeing the continuity of a service flow in an Internet system according to an embodiment of the present invention will be described with reference to accompanying drawings. At first, an anycast routing procedure between a terminal and a server will be described.

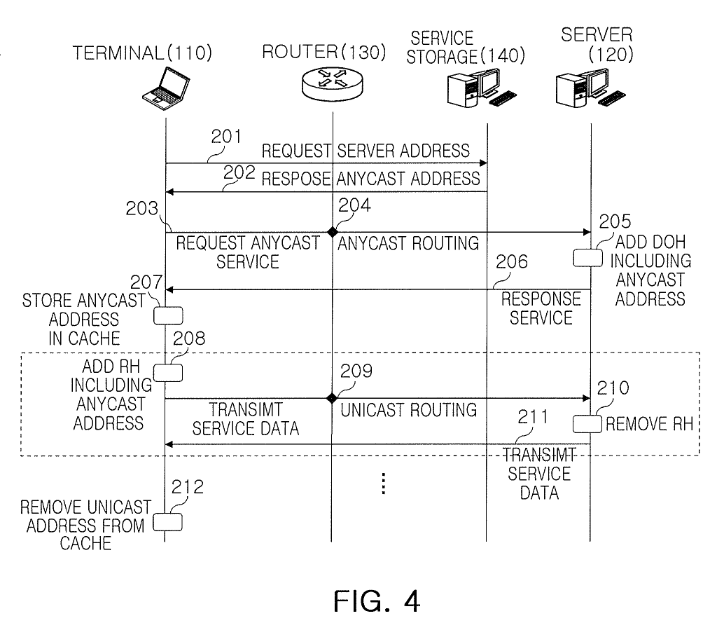

FIG. 4 is a diagram for describing an anycast routing method for guaranteeing a continuous service flow between a terminal and a server according to an embodiment of the present invention.

Referring to FIG. 4, the terminal 110 transmits a server address request message to a service storing unit 140, for example, a DNS server, at step S201. Then, the terminal 110 receives an anycast address response message having an anycast address stored in the service storing unit 140 at step S202. If the address of the server is well known or the terminal 110 additionally stores the address of the server, the steps S201 and S202 may not be performed.

Afterward, the terminal 110 transfers an anycast service request message having the anycast address to the server 120 through the router 130 at step S203. When the terminal 110 requests the service to the server 120 at the first time, that is, when the terminal 110 transmits the first packet to the server 120, a destination address is the anycast address. Since the destination address is the anycast address, the router 130 performs an anycast routing operation at step S204 in order to transfer the anycast service request message to the server 120.

At step S205, after the server 120 receives the anycast service request message, the server 120 inserts a destination option header (DOH) having a unicast address, adds the packet data with DOH into a service response message, and transmits the service response message to the terminal 110. Such a process is performed once when the service is firstly requested. Therefore, the server 120 informs the terminal 110 of the unicast address without adding additional protocol, thereby allowing the terminal 110 to continuously transfers packets of the continuous service flow to the same server.

If the terminal 110 receives the packet having the Ipv6 destination option header with a unicast address, the terminal 110 stores the unicast address mapped to a corresponding anycast address and a protocol port number thereof for identifying a corresponding service flow into the anycast cache 113 at step S206. The cache information stored in the anycast cache 113 include mapping information of an anycast address and a unicast address to perform a unicast routing operation in order to guarantee the continuity of the server flow, instead of performing an anycast routing operation that does not support the consecutive packets of the continuous service flow to be transmitted to the same fixed server.

After receiving application service data, the terminal 110 looks up the anycast cache at an IP layer, adds a mapped unicast address into the IPv6 routing header (RH) if a corresponding anycast address is present in the anycast cache, and exchange the destination anycast address with the unicast address of the routing header at step S207. Then, the terminal 110 transmits the RH added packet to the server 120 through the router 130 at step S209. The router 130 performs a unicast routing operation at step S210 in order to transfer the packet from the terminal 110. Since the form of the unicast address and the anycast address are identical in the IPv6, the router cannot discriminate the anycast routing process from the unicast routing process. However, since the unicast address exists at one interface only and the anycast address exists at a plurality of interfaces, a multi-path problem can be arisen at the router. Therefore, it cannot be guaranteed to always transfer packet to the same server.

At step S211, if the server 120 receives a packet having the IPv6 routing header, the server 120 exchange the anycast address of the routing header with the destination unicast address and removes the routing header. Although the unicast routing scheme is actually used to transfer packets to the same server, the application can use the anycast address as it is by processing the routing header (RH) at the IP layer of the server.

Afterward, the server 120 transmits service data transmission message to the terminal 110 with the anycast address of the server as a transmitter address and the unicast address of the terminal as the destination address without any additionally function and information at step S212. Then, the terminal 110 receives the service data transmission message and determines whether a continuous service flow is present or not at step S213. If the continuous service flow is present, the steps S207 to S213 are repeatedly performed. On the contrary, if the continuous service flow is not present, the terminal 110 removes a corresponding entry from the anycast cache 113 at step S214. If the service terminal is not informed to the terminal 110, the terminal 110 removes a corresponding entry according to a timer. That is, the terminal 110 removes a corresponding entry if one entry does not have any packet transmission for a predetermined time based on the timer. If such an entry deletion step is not performed, the advantage of load balancing in the anycast routing cannot be utilized because the terminal accesses only a server having the stored unicast address.

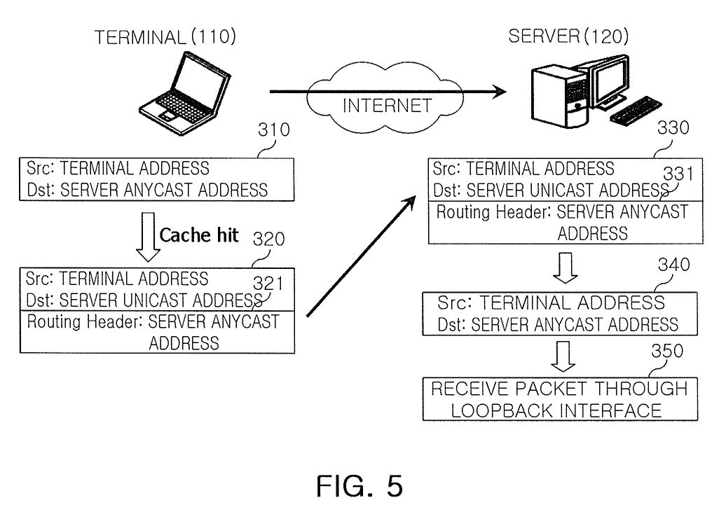

The steps S207 to S213 for processing an IPv6 anycast packet between the terminal 110 and the server 120 will be described with reference to FIG. 5, hereinafter.

Referring to FIG. 5, at the terminal 110, the source (Src) of a packet 310 for a service transferred from an application becomes a unicast address of the terminal, and the destination (Dst) becomes an anycast address of the server. If the destination anycast address of the packet is present in the anycast cache, the terminal 110 adds the routing header with the mapped anycast, and exchange the unicast address of the added routing header with a destination address. Accordingly, the destination address of a packet 320 becomes a unicast address of a server, is included in the routing header RH 321, and transferred to the server 120.

The packet 330 received at the server 120 from the terminal 110 has the unicast address 330 of the server as the destination, and the anycast address of a server is present in the routing header 331. Therefore, the server 120 exchanges the unicast address with the anycast address and removes the routing header (RH) 331. Then, the received packet 330 is a packet 340 including the anycast address of the server setup to the destination address of the basic header without having the expanded header. The anycast address is setup with a loopback interface in order to operate regardless of a physical interface. The server 120 receives packets 350 having the anycast address as the destination address through the loopback interface. Accordingly, the application can use the anycast address to service as it is.

Hereinafter, an anycast routing method for guaranteeing a service flow in an anycast routing apparatus such as a terminal and a server will be described.

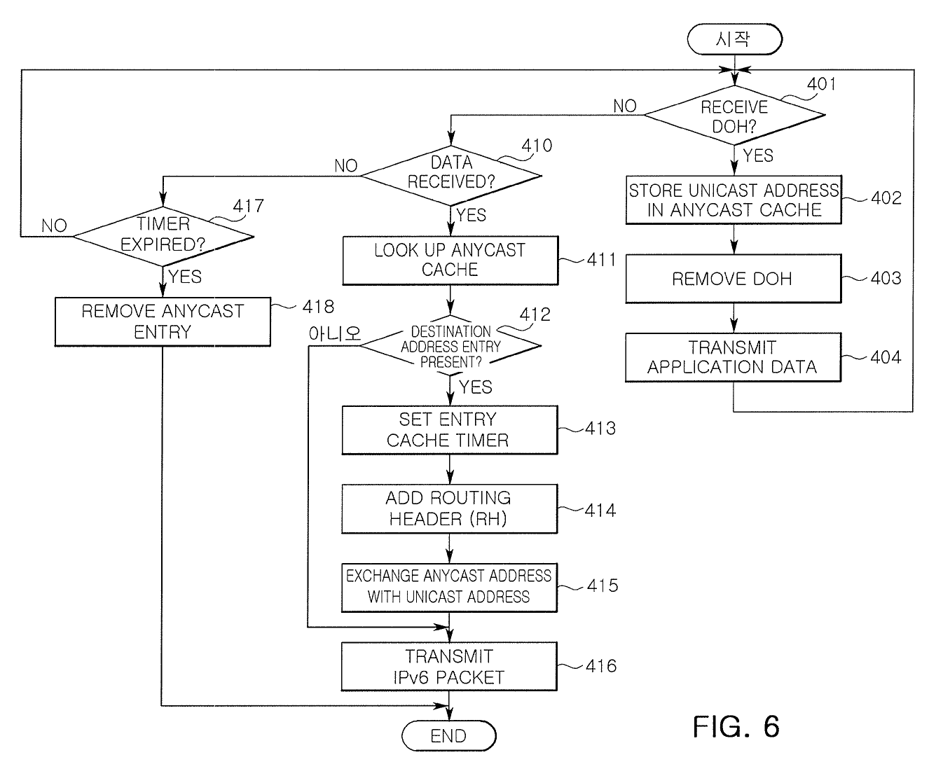

FIG. 6 is a flowchart illustrating an anycast routing method for guaranteeing a service flow in a terminal according to an embodiment of the present invention.

Referring to FIG. 6, the anycast cache manager 111 of the terminal 110 sets a valid time of an entry in an initial period by setting a default value of a terminal to set up each entry of an anycast cache. When the terminal 110 receives a packet including a destination option header (DOH) with a unicast address from the server 120 at step S401, the anycast cache manager 111 of the terminal 110 adds cache information including anycast address, unicast address, and a protocol port into the cache at step S402. Then, the terminal 110 removes the DOH from the received packet a step S403, and transfers the data to the application at step S404.

In case that the packet received from the server 120 at step S401 is not the packet having the DOH with the unicast address, if the routing header generator 112 receives application data from the application in the terminal 110 at step S410, the routing header generator 112 looks up the anycast cache 113 for the destination anycast address at step S411 and analyzes the lookup result to determine whether the anycast address is present or not at step S412. If the anycast address is present, the routing header generator 112 sets up a cache timer of a corresponding entry at step S413. Herein, if more than one of the anycast addresses are present, port numbers are also searched to lookup the entry. Then, at step S414, the routing header generator 112 adds a routing header with a unicast address corresponding the matched entry to a packet to transmit. The routing header generator 112 exchanges the destination anycast address with the unicast address of the routing header at step S415. Then, the routing header generator 112 transmits the IPv6 packet, service data, with the unicast address to the server 120 at step S416.

On the contrary, if an anycast address is not present after looking up the anycast cache at step S412, the routing header generator 112 transmits the IPv6 packet at step S416. The IPv6 packet is set up with anycast address since the destination address is not exchanged.

If data is not received from the application at step S410, the terminal 110 determines whether an entry timer expires or not from the anycast cache 113 at step S417. If the entry timer expires, the anycast cache manager 111 of the terminal 110 removes a corresponding anycast entry at step S418. Since it denotes that no data transmission is made for a timer period, the terminal treats it as that the service is interrupted. If the terminal 110 can detect the termination of the service flow, the anycast cache manager 113 removes the cache entry at the termination time. Therefore, additional timers are not required. On the contrary, if the entry timer does not expire, the terminal 110 sustains a waiting state and determines whether a packet is received or not at step s401.

Hereinafter, an anycast routing method for a server will be described.

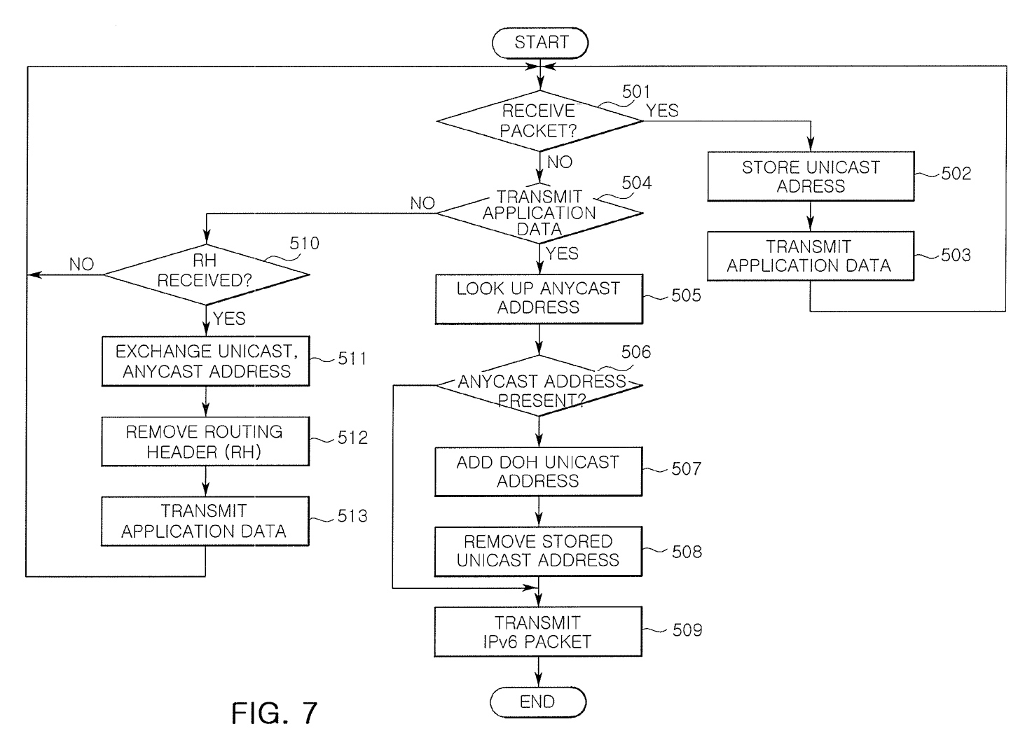

FIG. 7 is a flowchart illustrating an anycast routing method of a server according to an embodiment of the present invention.

Referring to FIG. 7, the server 120 receives a packet from the terminal 110 at step S501. The server 120 determines whether the received packet is the first packet or not at step S502. Then, if the received packet is the first packet, the unicast address transmitter 121 of the server 120 stores a mapped unicast address stored in the packet at step S503, and transmits the packet to the application at step S504.

If the unicast address transmitter 121 receives data from an application at step S505, the unicast address transmitter 121 looks up a cache to determine whether a unicast address is present in the cache or not at step S506. If the unicast address is present, the unicast address transmitter 121 adds the unicast address into the destination option header (DOH) of the IPv6 packet at step S507, and removes the unicast address stored in the cache at step S508. Then, the server 120 transmits the IPv6 packet having the unicast address in the DOH thereof to the terminal 110 at step S509.

On the contrary, if the unicast address is not present, the unicast address transmitter 121 does not add the DOH and performs the step S509 directly.

Meanwhile, if the received packet is not the first packet at step S502, the routing header processor 122 of the server 120 receives an IPv6 packet having a routing header. Therefore, the routing header processor 122 exchanges the destination unicast address with the anycast address included in the routing header if the routing header the received IPv6 packet includes the anycast address at step S511. Then, the routing header processor 122 removes the routing header at step S512, transmits data to the application at step S513, and waits to receive a packet by performing the step S501. Herein, a routing type II used in the mobile IPv6 can be used as the routing header. Also, an anycast address can be used instead of using the home address. The operation of the server, which receives and processes the routing type II header, is almost identical to that of the mobile IPv6 mobile terminal. Like as continuously providing a service using a home address to an application in the mobile IPv6, the continuity of the service using the anycast address to the application through the operation of the IP layer is guaranteed in the Mobile IPv6.

When the server transfers packets to the unicast address mapped to the anycast address, the terminal performs the unicast routing operation for the consecutive service packets. When the anycast address is transferred, the terminal uses the conventional IPv6 expanded header as it is. Therefore, no additional protocol is required.

The server transfers the unicast address once when the service starts, and the terminal only puts the anycast address into the packet to transfer to the server when the unicast routing operation is performed. Therefore, the packet transmitted from the server to the terminal is identical to that of the IPv6 routing operation. That is, the conventional IPv6 function can be used as it is, except anycast cache management in the IP layer.

As described above, the anycast routing method and apparatus according to the present embodiment do not need additional protocol because the conventional IPv6 expanded header is used as it is when the server transfers the unicast address mapped to an anycast address, or when the anycast address is transmitted together for performing the unicast routing operation at the terminal for consecutive service packets.

The invention can also be embodied as computer-readable codes on a computer-readable recording medium. The computer-readable recording medium is any data storage device that can store data which can be thereafter read by a computer system.

Examples of the computer-readable recording medium include read-only memory (ROM), random-access memory (RAM), CD-ROMs, magnetic tapes, floppy disks, optical data storage devices, and carrier waves (such as data transmission through the Internet). The computer-readable recording medium can also be distributed over network-coupled computer systems so that the computer-readable code is stored and executed in a distributed fashion.

While the present invention has been shown and described in connection with the preferred embodiments, it will be apparent to those skilled in the art that modifications and variations can be made without departing from the spirit and scope of the invention as defined by the appended claims.

As described above, the anycast routing method and apparatus according to the certain embodiment of the present invention transform the anycast routing to the unicast routing, thereby guaranteeing the consecutive IPv6 packets to be transmitted to the same anycast server.

Also, the anycast routing method and apparatus manages the unicast address mapped to the anycast address at the IP layer and transfers the anycast address to the application as it is. Therefore, the application can use the anycast address as it is without additional functions. That is, in the anycast routing method and apparatus according to the certain embodiment of the present invention, the application is not influenced although the unicast routing is performed. Furthermore, a relate service is not required to restart, thereby guaranteeing the continuity of the service flow.

What is claimed is:

1. An anycast routing method for guaranteeing a service flow transmitting to at least one of servers in a group in an in a terminal of an IPv6 (Internet protocol version 6) Internet system, comprising:
requesting an anycast service to at least one of the servers;
receiving a packet including an unicast address in a destination option header as a response for the anycast service request from at least one of the servers;
storing the unicast address in an anycast cache; and
transmitting a packet through an unicast routing operation using the unicast address stored in the anycast cache if data to transmit to the service flow is received from an application.

2. The anycast routing method according to claim 1, further comprising transferring data obtained by removing the destination option header in the received packet to the application.

3. The anycast routing method according to anyone of claims 1 and 2, further comprising transmitting consecutive packets to a same server where a previous packet is transmitted to according to a corresponding service flow using the stored unicast address if the consecutive packets are present.

4. The anycast routing method according to claim 1, wherein the step of transmitting the packet through the unicast routing operation includes:
looking up the stored unicast address when the data is received;
exchanging an anycast address of a destination address with the unicast address if it determines that an anycast entry is present based on the looking up result;
inserting a routing header set up with the exchanged anycast address into a packet of the service flow; and
transmitting the packet to the unicast address as a destination.

5. The anycast routing method according to claim 1, wherein the step of requesting the anycast server to at least one of the servers includes:
setting up a destination address of a first packet as an anycast address when the first packet is transmitted to a service flow of at least one of the servers; and
transmitting a packet including the anycast address to at least one of the servers through the anycast routing operation.

6. The anycast routing method according to claim 1, wherein the step of storing the unicast address includes:
mapping the unicast address to a corresponding anycast address; and
storing the unicast address mapped to the anycast address and a protocol port number to identify the service flow into the anycast cache.

7. The anycast routing method according to anyone of claims 6, wherein the unicast address is stored into the anycast cache only when the unicast address is transferred by being included in the destination option header, and the unicast address is removed from the anycast cache when a timer expires or when a service is terminated.

8. The anycast routing method according to claim 1, wherein the unicast address is included in the destination option header and received from at least one of the servers when a service start, and the unicast address is not included in packets received after the service starts.

9. An anycast routing method for guaranteeing a service flow receiving from a terminal in at least one of servers in a group of an IPv6 (Internet protocol version 6) Internet system, comprising:
transmitting a packet having a destination option header setup with a unicast address according to an anycast service request from the terminal;
receiving a packet having a routing header setup with an anycast address from the terminal through a unicast routing operation; and
processing the received packet.

10. The anycast routing method according to claim 9, wherein the step of transmitting the packet having the unicast address in the destination option header includes:
looking up the unicast address when a packet is firstly received through a service flow from the terminal;
adding the looked up unicast address into the destination option header; and
transmitting a packet having the destination option header to the terminal as a response for the service request.

11. The anycast routing method according to claim 9, wherein the step of processing the received packet includes:
exchanging a unicast address included in the received packet with an anycast address of a routing header;
removing the routing header setup with the exchanged unicast address from the received packet; and
transmitting data obtained by removing the routing header from the received packet to an application.

12. The anycast routing method according to claim 9, wherein the unicast address is included in the destination option header and transferred to the terminal when a service starts, and the unicast address is not included in packets after the service starts.

13. An anycast routing apparatus for guaranteeing a service flow transmitting to at least one of servers in a group in a terminal of an IPv6 (Internet protocol version 6) Internet system, comprising:
an anycast cache manager for receiving a packet having a destination option header setup with a unicast address as a response for an anycast service request from at least one of the servers, storing the unicast address in an anycast cache, and removing the unicast address from the anycast cache; and
a routing header generator for looking up the anycast cache to find a corresponding unicast address when receiving data of a service flow to transmit to at least one of the servers and transmitting a packet having a routing header using the corresponding unicast address through a unicast routing operation.

14. The anycast routing apparatus according to claim 13, wherein the anycast cache manager transfers data obtained by removing the destination option header from the received packet to the application.

15. The anycast routing apparatus according to claim 13, wherein the anycast cache manager transmits consecutive packets to a same server where a previous packet is transmitted to a corresponding service flow using a stored unicast address if the consecutive packets are present.

16. The anycast routing apparatus according to claims 13, wherein the anycast cache manager exchanges an anycast address of a destination address with the unicast address if it determines that an anycast entry is present based on the looking-up result, inserts a routing header setup with the exchanged anycast address into a packet of the service flow, and transmitting the packet of the service flow to a destination of the unicast address through the unicast routing operation.

17. The anycast routing apparatus according to claim 13, wherein the anycast cache stores cache information including the unicast address mapped to the anycast address and a protocol port number to identify the service flow.

18. The anycast routing apparatus according to claims 17, wherein the unicast address is stored in the anycast cache only when the unicast address is included in the destination option header and transferred, and the unicast address is removed when a timer expires or when a service is terminated.

19. The anycast routing apparatus according to claim 13, wherein the unicast address is added into the destination option header and received from at least one of the servers when a service starts, and the unicast address is not included in to packets after the service starts.

20. An anycast routing apparatus for guaranteeing a service flow receiving from a terminal in at least one of servers in a group of an IPv6 (Internet protocol version 6) Internet system, comprising:
a unicast address transmitter for transmitting a packet having a destination option header setup with a unicast address according to an anycast service request from the terminal; and
a routing header processor for receiving and processing a packet having a routing header setup with an anycast address through a unicast routing operation from the terminal.

21. The anycast routing apparatus according to claim 20, wherein the routing header processor exchanges a unicast address of the destination address included in the received packet with an anycast address of a routing header, removes the routing header having the unicast address from the received packet, and transmits data obtained by removing the routing header from the received packet to an application.

22. The anycast routing apparatus according to claim 20, wherein the unicast address is included in the destination option header of the packet and transferred to the terminal when a service starts, and the unicast address in not included after the service starts.
